(19) United States
(12) Patent Application Publication
(10) Pub. No.: US 2009/0106749 A1
(43) Pub. Date: Apr. 23, 2009

(54) SYSTEM, METHOD, AND COMPUTER SOFTWARE CODE FOR DETERMINING WHETHER A CHANGE IN A SUBSYSTEM IS COMPATIBLE WITH A SYSTEM

(76) Inventors: Wolfgang Daum, Erie, PA (US); John Erik Hershey, Ballston Lake, NY (US); Tom Otsubo, Oak Grove, MO (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/022,379

(22) Filed: Jan. 30, 2008

Related U.S. Application Data
(60) Provisional application No. 60/981,925, filed on Oct. 23, 2007.

(51) Int. Cl. G06F 9/445

(52) U.S. Cl. 717/168

(57) ABSTRACT

A method for determining whether a change in a complex system is compatible with the complex system, the method including determining whether at least one of a module change and a software change has occurred, determining whether the at least one of module change and software change results in a change in the operation of the complex system, and modifying a current operational state of the complex system to accommodate the at least one of module change and software change. A system and a computer software code are also disclosed for determining whether a change in a complex system is compatible with the complex system.

### CROSS-REFERENCE TO RELATED APPLICATIONS

This application is based on and claims priority to U.S. Provisional Application No. 60/981,925 filed Oct. 23, 2007.

### BACKGROUND OF THE INVENTION

The field of the invention relates to a complex system with a plurality of modules and software that may be upgraded, and more particularly, to a system, method, and computer software code for determining whether a change, such as a module upgrade and/or a software upgrade, in the complex system is compatible with the complex system.

Complex systems are usually composed of a plurality of subsystems, or individual modules. These individual modules are designed to interface to a host system in a manner that facilitates both upgrade and replacement of the individual modules as time for these events arise. Software upgrades may also be installed within either individual modules and/or the complete complex system.

A plurality of systems may be described as being a complex system. In a general view, a complex system may include electrical modules and mechanical modules that are interconnected with a core system. In a more specific view the complex system may include, but is not limited to, a railway transportation system, a marine vessel, an off-highway vehicle, and a stationary power generating station.

With respect to the railway transportation system, the complex system may be further identified as a locomotive and the locomotive may have a plurality of complex systems. For example, a railroad cab control system within the locomotive may be identified as the complex system. Since innovation of the railroad cab control system is on-going, development of module upgrades and/or software upgrades are not uncommon.

When considering the locomotive as the complex system, the basic locomotive typically is upgraded with module replacements and software upgrades designed to replace original modules and systems. Such upgrades are expected to comport to the same settings, protocols, functions, expected ranges, etc. of the original module or software. However, this is not always true. Situations arise where over time there are a sequence of upgrades provided by the locomotive manufacturer. The locomotive owner however may not implement each upgrade, preferring to continue operating the locomotive in an earlier configuration. When the owner finally decides to upgrade, specifically with the software upgrade, the owner may use the most recent known software upgrade, opting not to sequentially install the previous upgrades that were not previously installed. Taking such an approach may result in functionality that was to be provided in the previous, but uninstalled upgrades, not being available when the most recent upgrades in installed.

With respect to module upgrades, the owner may decide to use module upgrades provided by a third party vendor, more specifically a vendor other than the locomotive manufacturer. Such modules may not include all of the functionality that may be provided by modules provided by the locomotive manufacturer. For example, as modules are upgraded, a function that may have been provided in a first original module may not be included in a first replacement module. Instead that function may be included in a second replacement module that replaces a second module.

Locomotive operators and owners would benefit from knowing whether full functionality of the locomotive is available after upgrades are made. Likewise, operators and owners of other complex systems would benefit from knowing whether full functionality of the complex systems is available after upgrades are made. Furthermore, locomotive owners and operators as well as owners and operators of other complex systems would benefit from preventing damage to their respective subsystem or complex system if the upgrade does not provide equivalent functionality that the respective complex system provided prior to the upgrade.

### BRIEF DESCRIPTION OF THE INVENTION

A method for determining whether a change in a complex system is compatible with the complex system is disclosed. The method includes determining whether at least one of a module change and a software change has occurred. Determining whether the at least one of module change and software change results in a change in the operation of the complex system is also provided. Modifying a current operational state of the complex system to accommodate the at least one of module change and software change is further disclosed.

In another exemplary embodiment a system for determining whether a change in a complex system is compatible with the complex system is disclosed. The system includes a first detection device configured for determining whether at least one of a module change and a software change has occurred in the complex system. A second detection device configured for determining whether the at least one of module change and software change results in a change in the operation of the complex system is also provided. A monitoring device is configured for modifying a current operational state of the complex system to accommodate the at least one of module change and software change.

In another exemplary embodiment a computer software code operating within a processor and storable on computer readable media for determining whether a change in a complex system is compatible with the complex system is disclosed. The computer software code includes a computer software module for determining whether at least one of a module change and a software change has occurred. A computer software module is also provided for determining whether the at least one of module change and software change results in a change in the operation of the complex system. A computer software module for modifying a current operational state of the complex system to accommodate the at least one of module change and software change is further disclosed.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings, in which:

FIG. 1 depicts an exemplary flowchart for determining whether a change in a complex system is compatible with the complex system.

FIG. 2 depicts an exemplary block diagram of a system for determining whether a change in a complex system is compatible with the complex system.

FIG. 3 depicts an exemplary embodiment of a replacement module to be connected to a complex system;

FIG. 4 depicts an exemplary system for determining whether a replacement module integrated within a complex system provides at least equivalent functionality as an original module;

FIG. 5 depicts another exemplary configuration of a replacement module integrated to a complex system;

FIG. 6 depicts an exemplary flow chart for determining whether a replacement module integrated within a complex system provides at least equivalent functionality as an original module; and

FIG. 7 depicts an exemplary flow chart for determining whether at least equivalent functionality as the original module by using an association device.

### DETAILED DESCRIPTION OF THE INVENTION

Exemplary examples of the invention solves the problems in the art by providing a system, method, and computer software code, for allowing a reduced number of crew members, and/or crew members with reduced skills, to operate the rail vehicle, such as but not limited to a train with a virtual second crew member located at a remote location. Persons skilled in the art will recognize that an apparatus, such as a data processing system, including a CPU, memory, I/O, program storage, a connecting bus, and other appropriate components, could be programmed or otherwise designed to facilitate the practice of the method of an exemplary embodiment of the invention. Such a system would include appropriate program means for executing the method.

Broadly speaking, a technical effect is determining whether a change, such as a module upgrade and/or a software upgrade, in the complex system is compatible with the complex system. Embodiments of the invention may be described in the general context of computer-executable instructions, such as program modules, being executed by any device, such as but not limited to a computer and/or a processor, designed to accept data, perform prescribed mathematical and/or logical operations usually at high speed, where results of such operations may or may not be displayed. Generally, program modules may include routines, programs, objects, components, data structures, etc., that perform particular tasks or implement particular abstract data types. For example, the software programs that underlie embodiments of the invention can be coded in different programming languages, for use with different computing platforms. It will be appreciated, however, that the principles that underlie embodiments of the invention can be implemented with other types of computer software technologies as well. Towards this end the term software is used to describe a computer readable instruction that when executed by a processor causes the processor to perform a defined function and/or operation.

Moreover, those skilled in the art will appreciate that embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote computer storage media including memory storage devices.

Also, an article of manufacture, such as a pre-recorded disk, computer media, or other similar computer program product, for use with a data processing system, could include a storage medium and program means recorded thereon for directing the data processing system to facilitate the practice of embodiments of the method of the invention. Such apparatus and articles of manufacture also fall within the spirit and scope of the invention.

Referring now to the drawings, embodiments of the invention will be described. Embodiments of the invention can be implemented in numerous ways, including as a system (including a computer processing system), a method (including a computer implemented method), an apparatus, a computer readable medium, a computer program product, a graphical user interface, including a web portal, or a data structure tangibly fixed in a computer readable memory. Several embodiments of the invention are discussed below.

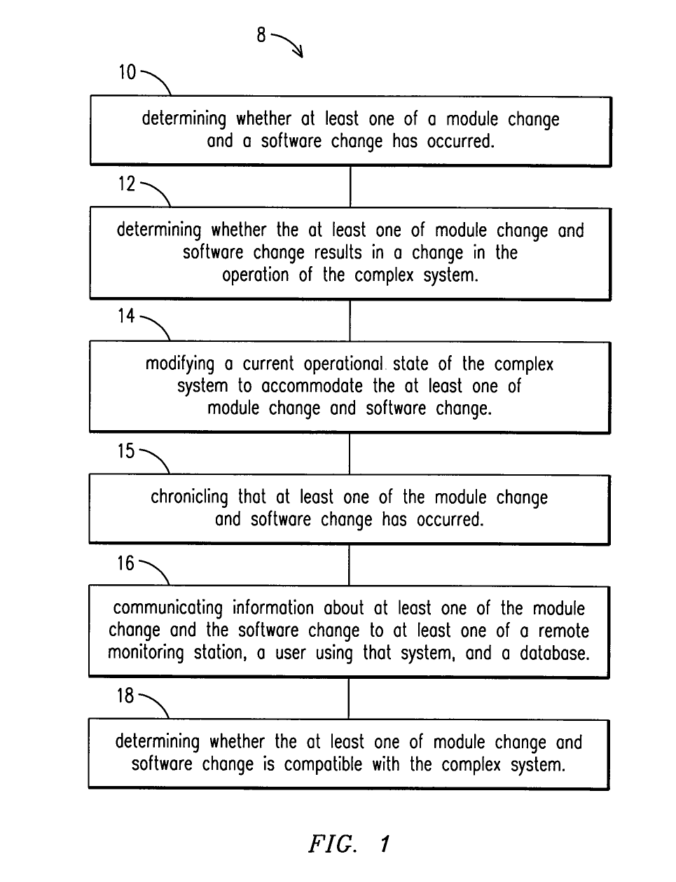

FIG. 1 depicts an exemplary flowchart for determining whether a change in a complex system is compatible with the complex system. The flowchart 8 provides for determining whether a module change and/or a software change has occurred, at 10. The change is not limited to an upgrade. The change may include a replacement that is being provided to change functionality. Determining whether at least the module change and/or the software change results in a change in the operation of the complex system, at 12, is further disclosed. Modifying a current operational state of the complex system to accommodate the module change and/or software change, at 14 is also disclosed. As disclosed above, the complex system 23 may include a railway transportation system, a marine vessel, an off-highway vehicle, and a stationary power generating station. As is also further disclosed above, the flowchart 8 may be implemented with a computer software code that is storable on computer media and operates with a processor.

When a module change and/or a software change is made, information regarding either change may be chronicled, at 15. This may be accomplished by communicating information about the module change and/or the software change to a remote monitoring station, a user using the system, and/or a database, at 16. The database may be located proximate the complex system. For example, when the complex system is a locomotive, the database may be aboard the locomotive. The database may also be located removed from the complex system, such as located at a depot. The information as well as communication technique used may be encrypted.

Once the module change and/or software change is made, an authentication, or determination, is accomplished to determine whether the module change and/or software change is compatible with the complex system, at 18. If the change is not compatible, the operations of the complex system experience a graceful degradation to avoid damage to the complex system. For example, with respect to the locomotive, the locomotive is allowed to work in a minimal level where it is operating at a level sufficient to allow continue its mission. Information about operating in the degraded state may be stored and/or communicated to the user or a remote monitoring station, as disclosed above.

Upgrading, or changing, the module and/or the software may be executed based on a pre-scheduled upgrade, an operational change for the complex system or a part of the complex system, and/or a change in the location of the complex system. For example, with respect to the change in the location of the complex system, when considering the locomotive, when the locomotive enters a region where emission limits are further limited, the locomotive may automatically upgrade certain software to insure the locomotive meets the emission limits for the region. Upon leaving the region, the locomotive may upgrade certain software back to a previous configuration. The change in the location of the locomotive may be determined by a remote location detection system, such as but not limited to a Global Positioning System.

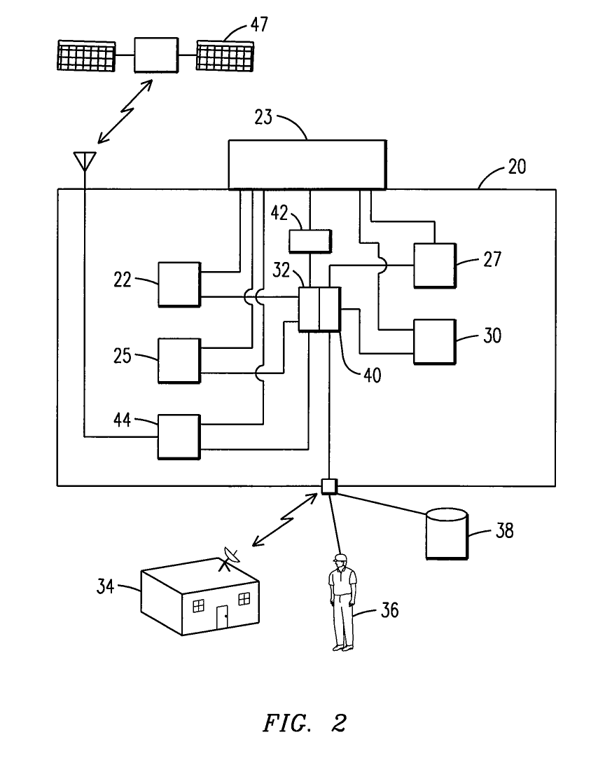

FIG. 2 discloses a block diagram of a system for determining whether a change in a complex system is compatible with the complex system. The system 20 has a first detection device 22 that is configured to determine whether a module change and/or a software change has occurred in the complex system 23. A second detection device 25 is configured to determine whether the module change and/or the software change results in a change in the operation of the complex system 23. A monitoring device 27 is configured to modify a current operational state of the complex system 23 to accommodate the module change and/or the software change. As discussed above, the complex system may be any multi-module system and or a computerized system such as but not limited to a railway transportation system, a marine vessel, an off-highway vehicle, and a stationary power generating station.

The system 20 may also include a recording device 30 configured to chronicle that the module change and/or the software change has occurred. The system 20 may also have a communication device 32 configured to communicated information about the module change and/or the software change to a remote monitoring station 34, a user 36, such as but not limited through a monitor or some other detection device. Information may also be communicated from the communication device 32 to a database 38 for later retrieval. The communication device 32 facilitates wired and/or wireless communication.

A third detection device 40 is configured to determine whether the module change and/or the software change is compatible with the complex system 23. A controller 42, in communication with the third detection device 40, is configured to operate the complex system 23 in a degraded operation state to avoid damage to the complex system 23 when the module change and/or software change is not compatible with the complex system 23. A locator system 44, such as a Global Positioning System, is further provided and is configured to determine the location of the complex system. Therefore the locator system may be physically part of the system 20, have elements that are part of the system while other elements are not part of the system 20, and/or be separate from the system 20. As illustrated parts of the locator system 44 are part of the system 20 while other parts, such as a satellite 47, are not. As further illustrated, all elements disclosed in FIG. 2 may be in communication with the communication device 32 which directs communication between appropriate elements.

Those skilled in the art will readily recognize that there are a plurality of ways to implement the flowchart 8 disclosed in FIG. 1, and/or the system disclosed in FIG. 2. The following are a few exemplary embodiments illustrating either implementation of the flowchart 8 and/or the system 20 disclosed in FIG. 2. Therefore the following embodiments are not presented as limiting the scope of the flowchart 8 and/or the system 20 disclosed above. Instead these exemplary embodiments are provided as further examples as to how the flowchart and/or system may be further refined for a specific embodiment.

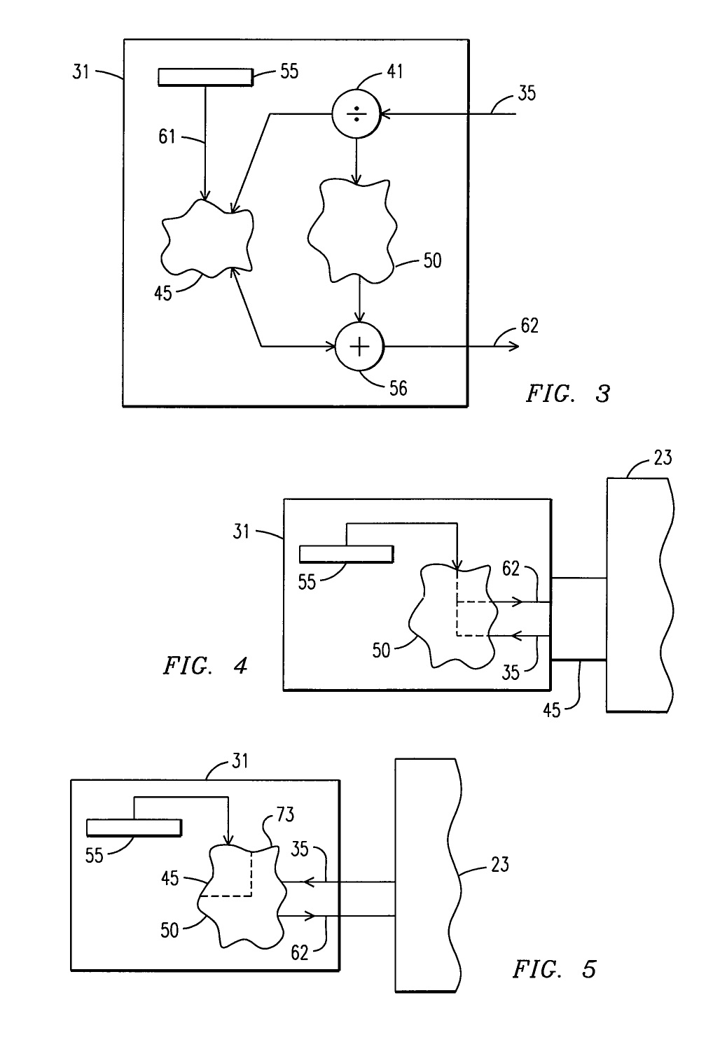

FIG. 3 depicts an exemplary embodiment of a replacement module for connection to a system. This replacement module 31 may also be referred to as an upgraded module and/or a module change. The information from the complex system 23 passes through a connection element 35 or an input element into the module 31. The connection element 35 may be an actual connector or a transmission line. Information may include, but is not limited to, commands, data, etc.

When the association information and non-association information is supplied through the same connection element 35, data transportation line or data line, a splitting means or a data separation device 41, separates the information. The association information is provided to an association function element 45. The non-association information is provided to a dispositional function element 50.

Though being illustrated as the information being provided through a connection element 35, those skilled in the art will recognize that such transmissions lines are not necessarily required. The various components that are part of the module can all be directly connected to the complex system 23.

The association element 45 is able to validate whether the replacement module 31 provides at least equivalent functionality as an original module. This may be accomplished by validating the module 31. Validation may be performed a plurality of ways. Such as, but not limited to, verification of host credentials may be accomplished by using encryption and/or authentication. In another example validation of the module's identity may be accomplished but sending specific data and evaluating its response. In another example validation is performed to determine that the module 31 is a proper module to perform the function that the complex system 23 expects. The data that transports this and similar information is termed “association information” or “association data.”

One specific way to determine verification is by using the module's serial number, or an identification element 55. The identification element 55 may reside within the association function element 45 or it may be conveyed to the association function element 45, such as via a second data transportation line 61. The association function element 45 may also perform and report to the complex system 23 information regarding the estimated health of the module 31. By doing so, the complex system may provide an advance warning if the module 31 is below a desired operating condition.

The dispositional function element 50 is considered the payload of the module 31. For example, its function may be as a sensor, computational element, a memory, an actuator, a data formatter, a combination of these functions, or any other function that provides data of value or adds value to data. That data involved with the data dispositional function is termed “non-association data.” The information outputted from the dispositional function element 50 and the information outputted from the association function element 45 are coupled together with a data coupling device 56. The combined data is then provided to the complex system 23 through an exit communication line 62. Both the coupling device 56 and the data separation device 41, or divider element, may be implemented through software.

FIG. 4 depicts another exemplary system for determining whether a replacement module integrated within a complex system provides at least equivalent functionality as an original module. Though FIG. 3 depicts the association function element 45 as being within the module 31, the association function element 45 may also be located a plurality of locations. For example, as illustrated, as association data and non-association data leaves the module, the association function element 45 may receive the data. Though in one exemplary embodiment, such as disclosed above, a divider element separates the data, but in another exemplary embodiment, the association function element 45 is able to differentiate between both forms of data, thus not requiring the data separation device 41. If the identification element 55, such as a serial number is also available, this information may be communicated with the data that is passed from the module 31 back to the complex system 23.

FIG. 5 depicts another configuration of a replacement module 45 integrated to a complex system. As illustrated, the association function element and the dispositional function element 50 may be a single element 73. Therefore the data separation device 41 and data coupling device 56 are not individual elements and all data lines 61 are internal to the combined single element 73.

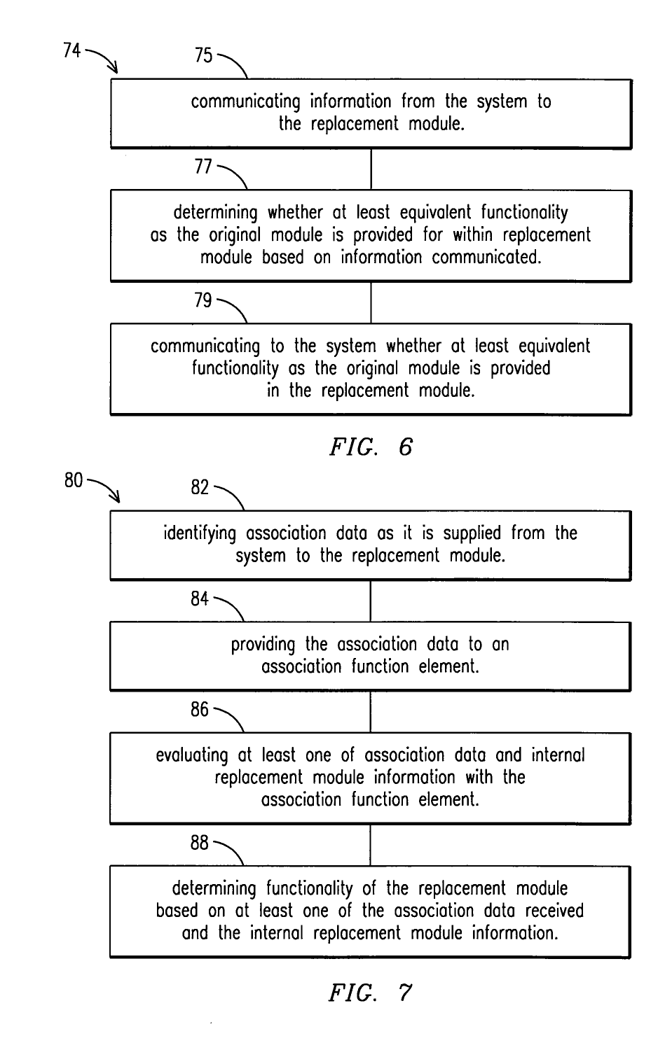

FIG. 6 depicts an exemplary flow chart for determining whether a replacement module integrated within a complex system provides at least equivalent functionality as an original module. The flowchart 74 discloses communicating information from the complex system to the replacement module, at 75. This may be accomplished once the replacement module 31 is in physical communication with the complex system 23. Once in communication a determination is completed to establish whether at least equivalent functionality as the original module is provide with the replacement module, at 77. This determination is accomplished based, in part, on processing of information communicated to the replacement module. Information about whether at least equivalent functionally as the original module is provided by the replacement module, at 79. As disclosed above, the flowchart 74 may be implemented with a computer software code that is storable on computer media and operates with a processor.

FIG. 7 depicts an exemplary flow chart for determining whether a replacement module integrated within a complex system provides at least equivalent functionality as the original module by using an association device. As illustrated in the flowchart 80 association information is communicated from the complex system, at 82. As disclosed herein, the association information may be separated from non-association data. The association data is delivered to an association function element, at 84. The association function element evaluates the association data and/or internal replacement module information, at 86. As disclosed herein the internal replacement module information may be its serial number. A determination is made regarding the functionality of the replacement module based on at least one of the association data received and the internal replacement module information, at 88. This flowchart 80 may be implemented with a computer software code that is storable on computer media and operates with a processor.

Though the above exemplary examples illustrated with respect to FIG. 3 through FIG. 7 are specific to a replacement module 31, those skilled in the art will readily recognize that these examples are also applicable to software changes. For example, the identification element 55 may be a software version and/or a specific line in a computer code that defines the software. Towards this end, with respect to FIG. 6, as an example, the flowchart 74 can be modified to replace the term “module” with “software” to further illustrate that the flowchart is applicable for software changes as well.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

That which is claimed:

1. A method for determining whether a change in a complex system is compatible with the complex system, the method comprising:
determining whether at least one of a module change and a software change has occurred;
determining whether the at least one of module change and software change results in a change in the operation of the complex system; and
modifying a current operational state of the complex system to accommodate the at least one of module change and software change.

2. The method according to claim 1 further comprising chronicling that at least on of the module change and the software change has occurred.

3. The method according to claim 1 further comprises communicating information about at least one of the module change and the software change to at least one of a remote monitoring station, a user using the system, and a database.

4. The method according to claim 1 further comprises determining whether the at least one of module change and software change is compatible with the complex system.

5. The method according to claim 1 wherein changing operations further comprises operating the complex system in a degraded operation state to avoid damage to the complex system when the at least one of module change and software change is not compatible with the complex system.

6. The method according to claim 1 wherein the at least one of module change and the software change is executed based on at least one of an upgrade, an operational change of the system, and a change in the location of the system.

7. The method according to claim 1 wherein the change in the location of the complex system is determined by a remote location detection system.

8. The method according to claim 1, wherein the complex system comprises at least one of a railway transportation system including a locomotive, a marine vessel, an off-highway vehicle, and a stationary power generating station.

9. A system for determining whether a change in a complex system is compatible with the complex system, the system comprising:
a first detection device configured to determine whether at least one of a module change and a software change has occurred in the complex system;
a second detection device configured to determine whether the at least one of module change and software change results in a change in the operation of the complex system; and
a monitoring device configured to modify a current operational state of the complex system to accommodate the at least one of module change and software change.

10. The system according to claim 9 wherein the complex system comprises at least one of a railway transportation system, a marine vessel, an off-highway vehicle, and a stationary power generating station.

11. The system according to claim 9 further comprises a recording device configured to chronicle that at least on of the module change and the software change has occurred.

12. The system according to claim 9 further comprises a communication device configured to communicate information about at least one of the module change and the software change to at least one of a remote monitoring station, a user using the system, and a database.

13. The system according to claim 12 wherein the communication device facilitates at least one of wired and wireless communication.

14. The system according to claim 9 further comprises a third detection device configured to determine whether the at least one of module change and software change is compatible with the complex system.

15. The system according to claim 9 further comprises a controller configured to operate the complex system in a degraded operation state to avoid damage to the complex system when the at least one of module change and software change is not compatible with the complex system.

16. The system according to claim 9 wherein the at least one of module change and the software change is executed based on at least one of an upgrade, an operational change of the complex system, and a change in the location of the complex system.

17. The system according to claim 15 further comprises a remote location detection system configured to determine the change in the location of the complex system.

18. A computer software code operating within a processor and storable on a computer readable media for determining whether a change in a complex system is compatible with the complex system, the computer software code comprising:
a computer software module for determining whether at least one of a module change and a software change has occurred;
a computer software module for determining whether the at least one of module change and software change results in a change in the operation of the complex system; and
a computer software module for modifying a current operational state of the complex system to accommodate the at least one of module change and software change.

19. The computer software code according to claim 18 further comprising a computer software module for chronicling that at least on of the module change and the software change has occurred.

20. The computer software code according to claim 18 further comprises a computer software module for communicating information about at least one of the module change and the software change to at least one of a remote monitoring station, a user using the system, and a database.

21. The computer software code according to claim 18 further comprises a computer software module for determining whether the at least one of module change and software change is compatible with the complex system.

22. The method according to claim 18 further comprises a computer software module for operating the complex system in a degraded operation state to avoid damage to the complex system when the at least one of module change and software change is not compatible with the complex system.
